(19) United States
(12) Patent Application Publication
(10) Pub. No.: US 2014/0144430 A1
(43) Pub. Date: May 29, 2014

(54) Protective Breathing Mask with Fabric Hood

(71) Applicant: Scott Health & Safety LTD, Lancashire (GB)

(72) Inventors: Kevin Dolan, Lancashire (GB); Neale Osmond, Lancashire (GB)

(73) Assignee: Scott Health & Safety LTD, Lancashire (GB)

(21) Appl. No.: 14/082,667

(22) Filed: Nov. 18, 2013

Related U.S. Application Data
(63) Continuation of application No. PCT/GB2012/051084, filed on May 16, 2012.

(30) Foreign Application Priority Data
May 16, 2011 (GB) 1108199.9

(51) Int. Cl. A62B 17/04; A62B 7/12

(52) U.S. Cl. CPC A62B 17/04; A62B 7/12
USPC 128/201.23; 2/9

(57) ABSTRACT

A protective breathing mask assembly comprises a face mask portion 10 having a brow support 5 at the top thereof which, in use, extends around the brow of the wearer, and a face seal 6 which extends around the back edge of the mask portion 10 so as, in use, to engage around the sides of the wearers face to prevent the ingress of material into the mask portion. The mask assembly further includes a rear of head strap 4 which extends between the ends of the brow support 5, in use, around the back of the wearers head. A crown strap 2 is connected to opposing sides of the mask assembly so as, in use, to extend across the top of the wearers head in opposing relation to the face seal 6, thereby pulling the face seal up against the wearers face. A head panel 1 extends between and is connected to the crown strap 2 and the rear of head strap 4 so as to be diametrically opposite to the face seal 6, and a hood 11 extends from the brow support 5 rearward over the head panel 1 so as, in use, to enclose the wearers head and protect against exposure to hazardous material whereby, in use, the head panel 1 engages the top of the wearer's head so as to properly locate the assembly on the wearers head.

### CROSS-REFERENCE TO RELATED APPLICATIONS

This application is a continuation of International Application No. PCT/GB2012/051084 filed May 16, 2012, which claims priority to GB Application No. 1108199.9 filed May 16, 2011, the contents of both of which are incorporated by reference.

### BACKGROUND OF THE INVENTION

Positive pressure breathing systems operate by delivering breathing gas into a mask so as to maintain a positive pressure therein. The pressure inside the mask then prevents hazardous particles from entering into the breathing atmosphere within the mask from the surroundings.

Positive pressure breathing masks are known in the art which incorporate a fabric hood which extends over the users head to protect against breathing in hazardous particles. Due to the manner in which the positive pressure within the mask prevents particles from the surrounding environment from entering the breathing atmosphere within the mask, the fabric hood typically has only an elastic seal to hold it in place around the users head.

One prior art such hooded mask is a one size fits all design in which the hood simply extends from the top of the mask rearward with an elasticated bottom which grips around the wearers head. The hood then protects the users head from hazardous material and also guards the top of the mask to prevent hazardous particles entering into the mask area. Variants of this prior art design also include a neck cap which extends down over the wearers neck and shoulders to extend the protection afforded by the mask.

The manner in which the hood is secured to the users head plays and important role in user protection and comfort. A good seal is required around the face and head to prevent contaminants entering the hood during breathing. The problem, however, is that the human head varies in shape and size, and this presents a challenge when designing a one size fits all solution—the hood should be able to adapt to different head and face shapes, as well as being able to provide good seal tension on small head sizes whilst not being uncomfortably tight on large head sizes.

The known prior art solves this problem by use of an elasticated head net which is provided inside the hood and extends rearward from a brow support, together with a neoprene face seal. This system improves user protection and comfort, being able to adapt to a wide variety of head shapes and sizes whilst maintaining the highest respiratory protection standard. However, the tension which retains the mask on the head only resolves to pull the face seal vertically onto the wearers face, so that the effectiveness of the seal is limited.

### SUMMARY OF THE PRESENT INVENTION

The present invention relates to breathing masks and more particularly to breathing masks which incorporate a fabric hood that extends over the head of the wearer to protect against breathing in hazardous particles.

### BRIEF DESCRIPTION OF THE DRAWINGS

The accompanying drawings, which are incorporated herein and constitute part of this specification, illustrate exemplary embodiments of the invention, and together with the description above, serve to explain further features of the invention.

FIG. 1 is a front perspective view of the internal mounting system of a mask according to the invention;

FIG. 2 is a rear perspective view of the mounting system of FIG. 1;

FIG. 3 is a side view of the mounting system of FIG. 1 with a hood and mask overlaid; and

FIG. 4 is a top view of the mask of the invention.

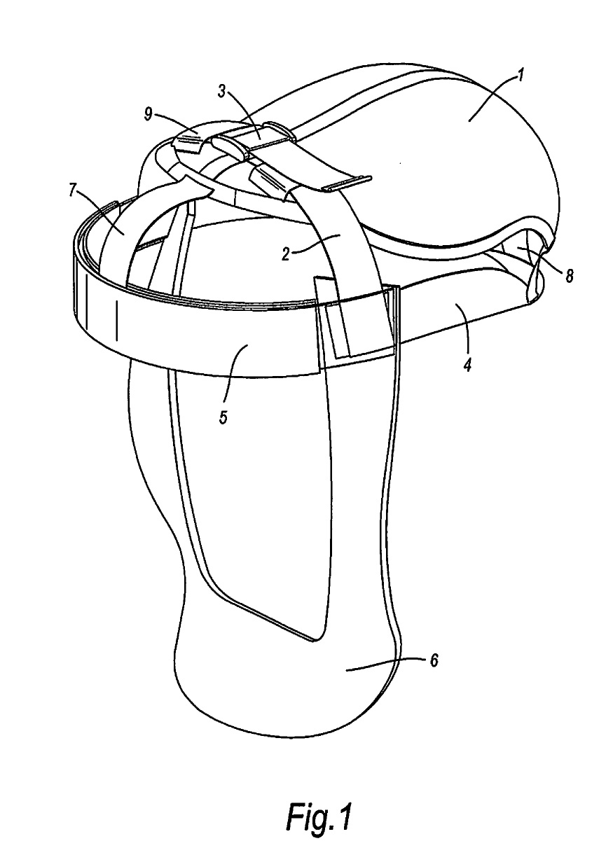

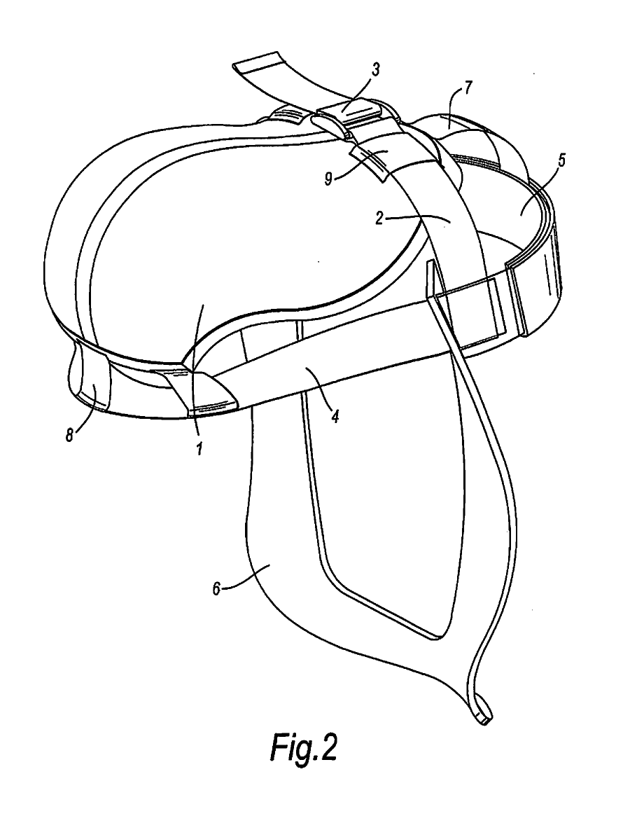

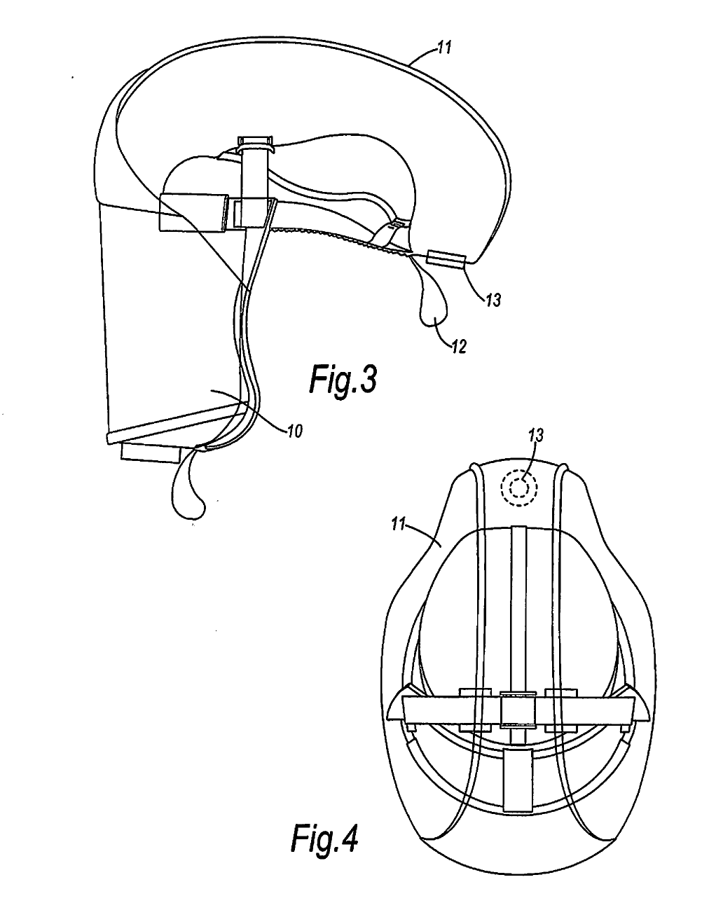

### DETAILED DESCRIPTION OF THE INVENTION

According to the present invention there is provided a protective breathing mask assembly comprising a face mask portion having a brow support at the top thereof which, in use, extends around the brow of the wearer, and a face seal which extends around the back of the mask portion so as, in use, to engage around the sides of the wearers face to prevent the ingress of material into the mask portion, wherein the mask assembly further includes a rear of head strap which extends between the ends of the brow support, in use, around the back of the wearers head, a crown strap which is connected to opposing sides of the mask assembly so as, in use, to extend across the top of the wearers head in opposing relation to the face seal, thereby pulling the face seal up against the wearers face; a head panel which extends between and is connected to the crown strap and the rear of head strap so as to be diametrically opposite to the face seal; and a hood which extends from the brow support rearward over the head panel so as, in use, to enclose the wearers head and protect against exposure to hazardous material; whereby, in use, the head panel engages the top of the wearer's head so as to properly locate the assembly on the wearers head.

A protective breathing mask assembly in accordance with the invention has the advantage that the provision of the head panel in diametric opposition to the face seal operates to pull the face seal up and back, rather than just up as was the case with the prior art systems, thereby improving the effectiveness of the seal.

Preferably, the hood is a flexible hood, in particular a fabric hood, and it advantageously has an air inlet opening at the rear thereof to which is connectable an inlet hose of a breathing air supply means such that breathing air is supplied into the back of the hood. This has the advantage that the air will tend to inflate the hood, making it more comfortable, and also the movement of air across the head of the wearer will help to help to keep the wearer cool.

The rear of head strap and crown strap are preferably elastic so as to accommodate heads of different sizes and shapes. However, they may alternatively or even additionally be adjustable by means of buckles, hook and loop material fastening systems or the like.

The head panel is preferably made of net fabric and is shaped to the typical contour of a wearers head.

Preferably, the head panel is attached at one end to the brow support, preferably adjustably connected and in particular connected by adjustable straps. The head panel is preferably attached at its back end to the rear head strap, in particular by elastic straps.

The front attachment of the head panel to the brow support is preferably achieved by means of at least one strap extending to the front of the brow support and at least one strap extending to either side of the brow support.

An important aspect of the invention is the connection of the head panel at the back of the hood, as this enables the apparatus to be fitted by the wearer hooking the apparatus onto the front of the head and them pulling down over the back of the head, the connection if the net member to the back of the hood/rear strap enabling the back of the net member to be pulled back over the head.

The present invention offers an intuitive to don system, that can adapt to a wide variety of head size and shapes whilst maintaining maximum respiratory protection Comfort has also been improved through spreading seal tension loads. In particular, the present invention offers the advantages of Improved head and face seal performance; One size fits all solution; Improved hood security; Improved user comfort; Easier/more intuitive to don

In a preferred improvement to the present invention; the face seal is formed through using a flat sheet of neoprene that is cut into a ‘U’ shape. When this is stitched into the hood it forms an adaptable seal that can bend and flex to the shape of any face. To ensure good contact is made with the face an elastic strap is preferably attached to the top ends of the neoprene panel that runs over the crown of the head. When the hood is donned this elastic strap stretches which applies a tension into the neoprene creating a good seal. The stretch of the elastic strap and flexibility of the neoprene face seal means that it can stretch to different sized heads, in order for the seal to remain comfortable on large head sizes it can be adjusted in length through a buckle to reduce tension, the opposite can also be done by shortening the elastic for smaller head sizes in order to maintain a good face seal tension.

In order to position this elastic strap in the correct position across the crown of the head it is attached to the head assembly. The head panel is directly attached to the brow support and rear head strap, which preferably forms an elastic seal, through a series of short elastic lengths. These prevent the head net from sitting too far forward or backward on top of the head. The large surface area of the head net provides good grip which improves the security of the overall hood, this system also keeps the elastic straps in their optimal position to provide tension into the head and face seals, a third benefit of the larger surface area is to spread the load of the elastic tensions across a wider area therefore improving comfort.

A common problem with current available hoods is the complexity of donning the hood correctly so the user gets maximum protection, floating brow pads, crown straps and harnesses can be tricky to align during the donning process. The head net system simplifies donning by connecting everything together, the user can see immediately where to position there head, once in place the head and face seals can be pulled down and donning is complete without the need for aligning any straps.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A protective breathing mask assembly comprising a face mask portion having a brow support at the top thereof which, in use, extends around the brow of the wearer, and a face seal which extends around the back of the mask portion so as, in use, to engage around the sides of the wearers face to prevent the ingress of material into the mask portion, wherein the mask assembly further includes a rear of head strap which extends between the ends of the brow support, in use, around the back of the wearers head, a crown strap which is connected to opposing sides of the mask assembly so as, in use, to extend across the top of the wearers head in opposing relation to the face seal, thereby pulling the face seal up against the wearers face, a head panel which extends between and is connected to the crown strap and the rear of head strap so as to be diametrically opposite to the face seal, and a hood which extends from the brow support rearward over the head panel so as, in use, to enclose the wearers head and protect against exposure to hazardous material, whereby, in use, the head panel engages the top of the wearer's head so as to properly locate the assembly on the wearers head.

2. A protective breathing mask assembly according to claim 1, wherein the hood is a flexible hood, in particular a fabric hood.

3. A protective breathing mask assembly according to claim 1, wherein the hood has an air inlet opening at the rear thereof to which is connectable an inlet hose of a breathing air supply means such that breathing air is supplied into the back of the hood.

4. A protective breathing mask assembly according to claim 1, wherein the rear of head strap and crown strap are at least one of elasticated and adjustable by means of buckles, hook and loop material fastening systems so as to accommodate heads of different sizes and/or shapes.

5. A protective breathing mask assembly according to claim 1, wherein the head panel is made of net fabric.

6. A protective breathing mask assembly according claim 1, wherein the head panel is attached at the front end to the brow support, and at the back end to the rear head strap.

7. A protective breathing mask assembly according to claim 6, wherein the front attachment of the head panel to the brow support is achieved by means of at least one strap extending to the front of the brow support and at least one strap extending to either side of the brow support.

8. A protective breathing mask assembly according to claim 1, wherein the face seal is formed having a flat sheet of neoprene that is cut into a ‘U’ shape and fastened to the hood so as to form an adaptable seal that can bend and flex to the shape of any face.
